(19) United States
(12) Patent Application Publication
(10) Pub. No.: US 2022/0245665 A1
(43) Pub. Date: Aug. 4, 2022

(54) MODIFICATION OF ELECTRONIC CONTENT IDENTIFIED BY A TRANSMISSION OF AN INDICATION OF THE ONLINE CONTENT AFTER THE TRANSMISSION

(71) Applicant: Groupon, Inc., Chicago, IL (US)

(72) Inventors: Jerry Richard VOSS, Chicago, IL (US); Shafiq SHARIFF, Chicago, IL (US)

(21) Appl. No.: 17/647,751

(22) Filed: Jan. 12, 2022

Related U.S. Application Data
(63) Continuation of application No. 13/796,635, filed on Mar. 12, 2013, now abandoned.
(60) Provisional application No. 61/639,067, filed on Apr. 26, 2012.

(51) Int. Cl. G06Q 30/02

(52) U.S. Cl. CPC G06Q 30/0235

(57) ABSTRACT

Various methods, apparatus, and systems are provided for modifying displayed characteristics of electronic content identified by a transmission identifying the online content after the transmission. One example apparatus may be configured to provide, via one of e-mail, text message, application alert, or mobile application, to each of a plurality of consumer devices, an indication of an availability of electronic media having a first expiration date, receive, from a consumer device, an acceptance of the electronic media, provide first content indicative of the electronic media displaying a first expiration date, receive, from a second consumer device, a second acceptance of the electronic media, modify the first content to comprise a second expiration date, and present, via display at the second consumer device, second content, the second content being the modified first content, and comprising the second expiration date.

### CROSS-REFERENCE TO RELATED APPLICATIONS

This non-provisional application is a continuation of U.S. patent application Ser. No. 13/796,635, titled “Deal Meter,” filed Mar. 12, 2013, which claims the benefit of U.S. Provisional Patent Application No. 61/639,067, filed Apr. 26, 2012, the entire contents of which are incorporated herein by reference.

### TECHNICAL FIELD

The present description relates to how to efficiently and effectively manage promotion metering. More specifically, the present description relates to a way to manage the number of impressions issued to a user population.

### BACKGROUND

Merchants may offer promotions to attract consumers and ultimately increase sales and revenue. In some cases, merchants may partner with a promotion and marketing service to develop and distribute these promotions to a user population. Consumers may subsequently redeem promotions and purchase goods or services from the merchants. Applicant has identified a number of deficiencies and problems associated with the development, distribution, and redemption of promotions. Through applied effort, ingenuity, and innovation, Applicant has solved many of these identified problems by developing a solution that is embodied by the present invention, which is described in detail below.

### BRIEF SUMMARY

The deal meter provides an effective and efficient way to manage the number of impressions issued to a user population to achieve an expected frequency of redemptions of promotions.

In one example embodiment, a method is provided including the steps of receiving redemption parameters from a merchant, selecting a promotion from a set of promotions based on the redemption parameters, and determining a number of impressions based on the redemption parameters, wherein each impression correlates to the promotion.

In one embodiment, selection of the promotion from the set of promotions is further based on at least one of a promotion acceptance ratio and a promotion redemption ratio. In another embodiment, the number of impressions is further based on the promotion. The method may further include determining a redemption term for the promotion based on the redemption parameters.

In another embodiment, the method may include determining a first redemption term for the promotion based on the redemption parameters, correlating the first redemption term to a first group of impressions, determining a second redemption term for the promotion based on the redemption parameters, a promotion acceptance ratio, or a promotion redemption ratio, and correlating the second redemption term to a second group of impressions.

In yet another embodiment, the method may include determining a redemption term for the promotion based on the redemption parameters, a promotion acceptance ratio, or a promotion redemption ratio. Additionally or alternatively, the method may include determining an impression issuance schedule based on the redemption parameters and at least one of a promotion acceptance ratio or a promotion redemption ratio.

The method may include determining a redemption term for the promotion based on the redemption parameters and the impression issuance schedule. In another embodiment, the method may include determining an impression issuance schedule based on the redemption parameters, the promotion, a promotion acceptance ratio, and a promotion redemption ratio. In some instances, the determining the impression issuance schedule is also based on the number of impressions. Further, the determining the impression issuance schedule may include determining a first group of impressions for issuance at a first time and determining a second group of impressions for issuance at a second time. In this regard, the method may include determining a first redemption term for the promotion based on the redemption parameters, correlating the first redemption term to the first group of impressions, determining a second redemption term for the promotion based on the redemption parameters, a promotion acceptance ratio, or a promotion redemption ratio, and correlating the second redemption term to the second group of impressions.

In another embodiment, the method may include issuing the number of impressions based on the impression issuance schedule. In this case, the determining the impression issuance schedule may include determining a first group of impressions for issuance at a first time, wherein the determining the first group of impressions is based on the redemption parameters, the promotion, the promotion acceptance ratio, and the promotion redemption ratio and determining a second group of impressions for issuance at a second time, wherein the determining the second group of impressions is based on the redemption parameters, the promotion, the promotion acceptance ratio, and the promotion redemption ratio. Furthermore, determining the impression issuance schedule may include determining a third group of impressions for issuance at a third time, wherein the determining the third group of impressions is based on the redemption parameters, the promotion, the promotion acceptance ratio, and the promotion redemption ratio.

In another embodiment, the method may include determining a first user population based on the redemption parameters and issuing a first group of impressions to the first user population. In this regard, the method may further include determining a second user population based on the redemption parameters and at least one of the promotion, a promotion acceptance ratio, and a promotion redemption ratio and issuing a second group of impressions to the second user population. In another embodiment, the redemption parameters comprise at least one of a total number of redemptions and a promotion redemption rate.

In yet another embodiment, the method may include determining a first redemption term for the promotion based on the redemption parameters, determining a first group of impressions based on the redemption parameters, the promotion, a promotion acceptance ratio, and a promotion redemption ratio, correlating the first redemption term to the first group of impressions, determining a first user population based on the redemption parameters, and issuing the first group of impressions to the first user population. In this case, the method may further include determining a second redemption term for the promotion based on the redemption parameters, determining a second group of impressions based on the redemption parameters, the promotion, the promotion acceptance ratio, and the promotion redemption ratio, correlating the second redemption term to the second group of impressions, determining a second user population based on the redemption parameters, and issuing the second group of impressions to the second user population.

In another example embodiment, an apparatus is provided including a processor and a non-transitory computer-readable medium having computer-readable program instructions stored therein, the computer-readable program instructions, when performed by the apparatus, are configured to cause the apparatus to receive redemption parameters from a merchant, select a promotion from a set of promotions based on the redemption parameters, and determine a number of impressions based on the redemption parameters, wherein each impression correlates to the promotion.

In another example embodiment, a computer program product is provided including at least one non-transitory computer-readable storage medium having computer-readable program instructions stored therein, the computer-readable program code instructions, when executed, cause an apparatus to receive redemption parameters from a merchant, select a promotion from a set of promotions based on the redemption parameters, and determine a number of impressions based on the redemption parameters, wherein each impression correlates to the promotion.

In yet another example embodiment, an apparatus is provided including means for receiving redemption parameters from a merchant, selecting a promotion from a set of promotions based on the redemption parameters, and determining a number of impressions based on the redemption parameters, wherein each impression correlates to the promotion.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described some embodiments in general terms, reference will now be made to the accompanying drawings, which are not necessarily drawn to scale, and wherein:

FIG. 1 shows components of a deal meter system configuration, in accordance with some example embodiments;

FIG. 2 shows operations for determining a number of impressions, in accordance with some example embodiments;

FIG. 3 shows a plot of a number of redemptions of a promotion over the lifetime of the promotion;

FIG. 4 shows operations for determining an issuance schedule, in accordance with some example embodiments; and

FIG. 5 shows operations for determining an issuance schedule and issuing impressions, according to some example embodiments.

### DETAILED DESCRIPTION

Various embodiments will now be described more fully with reference to the accompanying drawings. These inventions may be embodied in many different forms and should not be construed as limited to the embodiments set forth herein; rather, these embodiments are provided so that this disclosure will satisfy applicable legal requirements. Like numbers refer to like elements throughout.

### Definitions

As used herein, a “promotion” (i.e., a deal) may include, but is not limited to, any type of offered, presented or otherwise indicated reward, discount, coupon, credit, incentive, discount, media or the like that is indicative of a promotional value or the like that, upon purchase or acceptance, results in the issuance of an instrument that may be used toward at least a portion of the purchase of particular goods, services and/or experiences defined by the promotion. In some examples, the promotion defines an accepted value (e.g., a cost to purchase the promotion), a promotional value (e.g., the value of the resultant instrument beyond the accepted value), a residual value (e.g. the value upon return or upon expiry of one or more redemption parameters), one or more redemptions parameters and/or the like. For example, an example promotion may be “$20 for $40 worth of merchandise at ACME department store.”

As used herein, an “impression” may be a communication, display, or other perceived indication, such as a flyer, print media, e-mail, text message, application alert, mobile applications, any other type of electronic interface or distribution channel and/or the like, of one or more promotions. In this regard, an impression may include an offer of a promotion. Using the example promotion above, an impression may comprise an email to a user including the $20 for $40 promotion.

As used herein, a “promotion and marketing service” (e.g., Groupon), which may at times be referred to as a service provider, may include a service that is accessible via one or more computing devices and is operable to provide example promotion and/or marketing services on behalf of one or more providers that are offering one or more instruments that are redeemable for goods, services, experiences and/or the like. The promotion and marketing service is further configured to illustrate or otherwise inform one or more consumers of the availability of one or more instruments in the form of one or more impressions. In some examples, the promotion and marketing service may also take the form of a redemption authority, a payment processor, a rewards provider, an entity in a financial network, a promoter, an agent, and/or the like. As such, the service is, in some example embodiments, configured to present one or more promotions via one or more impressions, accept payments for promotions from consumers, issue instruments upon acceptance of an offer, participate in redemption, generate rewards, provide a point of sale device or service, issue payments to providers and/or otherwise participate in the exchange of goods, services or experiences for currency, value and/or the like. Using the above example, the promotion and marketing service may issue the impression containing an indication of the $20 for $40 promotion.

As used herein, an “acceptance” of a promotion may take the form of a transaction between a user and a promotion and marketing service in which the user offers payment to the promotion and marketing service in exchange for an instrument that embodies the terms of the promotion and which is redeemable at a merchant. In the above example, acceptance of the promotion may comprise a user paying a promotion and marketing service $20 in exchange for an instrument that may be redeemed at the ACME department store.

In this regard, the “instrument” may include, but is not limited to, any type of gift card, tender, electronic certificate, medium of exchange, voucher, or the like that embodies the terms of the promotion from which the instrument resulted and may be used toward at least a portion of the purchase, acquisition, procurement, consumption or the like of goods, services and/or experiences. In some examples, the instrument may take the form of tender that has a given value that is exchangeable for goods, services and/or experiences and/or a reduction in a purchase price of a particular good, service or experience. In some examples, the instrument may have multiple values, such as accepted value, a promotional value and/or a residual value. In some examples, the accepted value of the instrument is defined by the value exchanged for the instrument. In some examples, the promotional value is defined by the promotion from which the instrument resulted and is the value of the instrument beyond the accepted value. In some examples, the residual value is the value after redemption, the value after the expiry or other violation of a redemption parameter, the return or exchange value of the instrument and/or the like. In the above example, one example instrument may be a printout with the promotion details.

As used herein, “redemption” of a promotion may include the use, exchange or other presentation of an instrument for at least a portion of a good, service or experience as defined by the instrument and its related promotion. In some examples, redemption includes the verification of validity of the instrument. In other example embodiments, redemption may include an indication that a particular instrument has been redeemed and thus no longer retains an actual, promotional or residual value (e.g., full redemption). In other example embodiments, redemption may include the redemption of at least a portion of its actual, promotional and/or residual value (e.g., partial redemption). In the above example, the instrument may redeemed by providing it in exchange for $40 worth of merchandise at the ACME department store.

As used herein, “redemption parameters” may be any requirements or constraints that mandate or restrict the nature of promotions that may be offered on the merchant's behalf. In this regard, redemption parameters may include, but are not limited to, a total number of redemptions, a promotion redemption ratio, specific information regarding one or more promotions, or a redemption term. In the above example, a redemption parameter may be a total number of $20 for $40 promotions that ACME would like to be redeemed.

As used herein, a “redemption term” may include an effective (or sale) date and an expiration date of a promotion. Alternatively, a redemption term may include an effective term, which indicates a period of time, starting from acceptance of a promotion, during which the promotion may be redeemed. The effective date of the above-described $20 for $40 deal may be the date of acceptance of the promotion, and a manager at ACME department store may specify an expiration date or an effective term as a redemption parameter.

As used herein, a “promotion acceptance ratio” is a percentage of impressions that result in accepted promotions. For example, if 100 impressions are issued, and as a result 50 promotions are accepted, the promotion acceptance ratio is 50 promotion acceptances for every 100 impressions, or 50%.

As used herein, a “promotion redemption ratio” is a percentage of accepted promotions that are redeemed. For example, if 50 promotions are accepted, and as a result 25 promotions are redeemed by users, the promotion redemption ratio is 25 promotion redemptions for every 50 promotion acceptances, or 50%.

As used herein, a “promotion redemption rate” is a rate per unit time at which an accepted promotion is redeemed. For example, if 100 promotions are redeemed by consumers in a 10 day span, the promotion redemption rate may be described as 10 promotion redemptions per day.

### Overview

Currently, merchants lack a way to effectively manage the number of promotions that will be redeemed by customers or the rate at which customers will redeem the promotions. For instance, although a fixed number of impressions may be sent to a user population, only a subset of the impressions will result in accepted promotions and only a percentage of the accepted promotions will ever be redeemed. In this respect, the merchant must attempt to estimate the number of impressions necessary to achieve a desired number of redemptions, and the merchant may receive a much different amount of user traffic than desired. Similarly, the redemptions that do occur may be unevenly distributed throughout a redemption term, so merchants that lack the capacity to accommodate a large number of redemptions in a short period of time may be overwhelmed. Accordingly, merchants are often discouraged from using promotions to generate customer traffic.

The deal meter provides a way to efficiently and effectively offer promotions over configurable time periods for a merchant. A promotion and marketing service may use the deal meter to provide merchants with a deal metering solution. The deal meter provides a merchant a way to manage the number of impressions made available to the merchant's customers based on a promotion acceptance ratio and a promotion redemption ratio.

The deal meter may use a compilation of promotions and, rather than using a fixed duration (e.g., a one week promotion), the merchant specifies how many customers the merchant desires to have redeem promotions in a given time period (e.g., 1000 redeemed promotions per month). The deal meter meters out the number of impressions of the compilation of promotions. The deal meter predicts the number of promotions that the customers may redeem for a given time period. The deal meter forecasts the number of offers (or impressions) the customers may accept, and the number of accepted promotions redeemed for a given time period (e.g., the promotion redemption ratio). In order to provide the merchant with an expected promotion redemption rate, the deal meter may vary the number of impressions for a promotion offered during a given time period, or vary the effective date and/or expiration date of the accepted promotion, or both. The deal meter may use observations of the promotion acceptance ratio and the promotion redemption ratio from a previous time period to forecast the promotion acceptance ratio and the promotion redemption ratio for one or more subsequent time periods.

Typically, accepted promotions are redeemed soon after acceptance or close to expiration of the redemption term. In this way, a merchant may expect a spike in redemptions at those two periods. In order to reduce the spikes in redemptions, the deal meter delivers customers to merchants on a more constant basis. Rather than feature a promotion all at once to a large number of customers, the deal meter meters the impressions to a lot of users, but at a steadier rate and over a longer period of time. The merchant decides how many accepted promotions the merchant wishes to redeem in a given time period (e.g., month) and the deal meter offers the promotion to a specified number of customers through one or more targeted marketing channels.

The deal meter may initially feature promotions to a small audience of customers (e.g., potential customers) as pre-featured promotions in order to gather data to determine the promotion acceptance ratio for the promotion, and to determine what user population has the highest promotion acceptance ratio, and allocate inventory into a compilation of promotions (e.g., used to present offers to targeted customer profiles) that provide impressions through a variety of marketing channels. The deal meter may use pre-featured promotions to initially forecast promotion acceptance ratios and promotion redemption ratios for promotions, subsequently offer promotions to subscribers of the promotion and marketing service (e.g. a larger audience) and refine the forecasted promotion acceptance ratios and promotion redemption ratios for subsequent periods of time, and thereafter offer promotions from a promotion database 120 (e.g., a deal bank that stores a compilation of promotions) to targeted customers. The deal meter may iterate refinements to the promotion acceptance ratios and promotion redemption ratios for subsequent periods of time in order to provide merchants a predictable rate of customers. The deal meter may adjust the promotions offered over the course of time based on prior time periods' promotion acceptance ratios and promotion redemption ratios for promotions, in order to create a better and more personalized customer experience.

The deal meter provides a better merchant experience by providing the merchant a steadier stream of customers; rather than the merchant experiencing a big rush at the beginning and end of a promotion (e.g., one week offer), the deal meter may stagger sales and expiration dates for promotions in order to smooth out the customer flow (promotion redemption rate). The deal meter provides merchants with the ability to set a fixed expiration date for the promotions, or set the expiration date relative to the date on which a customer accepts a promotion rather than fixing the expiration date to the date when the promotion launches. The deal meter may therefore benefit merchants that do not seek a large volume of new customers, but who desire a steady flow of new customers on a configurable frequency (e.g., monthly). The deal meter may allow merchants to strategically use promotions long term.

### Example Technical Platform

The methods described herein may be implemented by software programs executable by a computer system. Some implementations may include distributed processing, component/object distributed processing, and parallel processing. Alternatively or in addition, virtual computer system processing maybe used to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

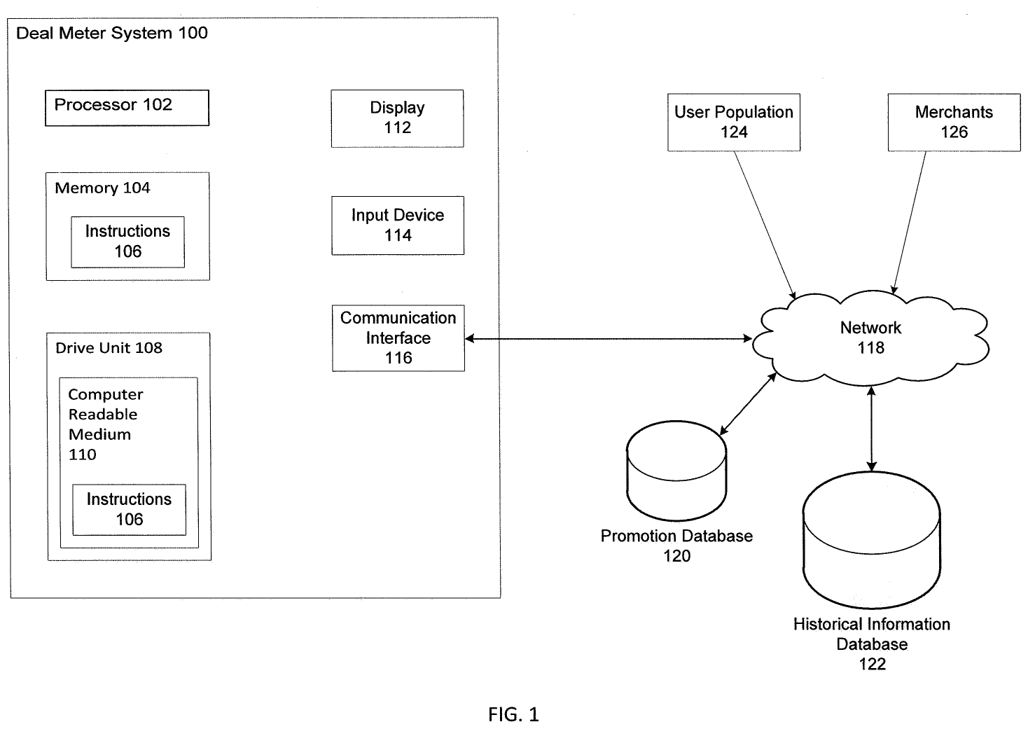

FIG. 1 shows components 100 of the deal meter system configuration. Also shown are promotion database 120 and historical information database 122. Promotion database 120 stores sets of promotions that may be associated with one or more merchants. Historical information database 122 stores promotion acceptance ratios, promotion redemption ratios, and promotion redemption rates for the promotions stored in promotion database 120, if such historical information is available. Although promotion database 120 and historical information database 122 are illustrated as separate from the deal meter system 100, in some embodiments they may instead be components of the deal meter. In other embodiments, the deal meter 100 and the databases 120 and 122 may be co-hosted by a promotion marketing service. In yet other embodiments, the deal meter 100 may be hosted by a merchant 126, while the databases 120 and 122 are hosted or otherwise under the control of the promotion marketing service. Of course, other configurations are contemplated in which the deal meter 100 may communicate with databases 120 and 122.

The deal meter system 100 may be deployed as a general computer system used in a networked deployment. The computer system may operate in the capacity of a server or as a client user computer in a server-client user network environment, or as a peer computer system in a peer-to-peer (or distributed) network environment. The computer system may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system may be implemented using electronic devices that provide voice, video or data communication. Further, while a single computer system may be illustrated, the term “system” shall also be taken to include any collection of systems or sub-systems that individually or jointly execute a set, or multiple sets, of instructions to perform one or more computer functions.

The computer system may include a processor 102, such as a central processing unit (CPU), a graphics processing unit (GPU), or both. The processor may be a component in a variety of systems. For example, the processor may be part of a standard personal computer or a workstation. The processor may be one or more general processors, digital signal processors, application specific integrated circuits, field programmable gate arrays, servers, networks, digital circuits, analog circuits, combinations thereof, or other now known or later developed devices for analyzing and processing data. The processors and memories discussed herein, as well as the claims below, may be embodied in and implemented in one or multiple physical chips or circuit combinations. The processor may execute a software program, such as code generated manually (i.e., programmed).

The computer system may include a memory 104 that can communicate via a bus. The memory may be a main memory, a static memory, or a dynamic memory. The memory may include, but may not be limited to, computer readable medium 110 such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory may include a cache or random access memory for the processor. Alternatively or in addition, the memory may be separate from the processor, such as a cache memory of a processor, the memory, or other memory. The memory may be an external storage device or database for storing data. Examples may include a hard drive, compact disc (“CD”), digital video disc (“DVD”), memory card, memory stick, floppy disc, universal serial bus (“USB”) memory device, or any other device operative to store data. In any event, the computer readable medium may be non-transitory. The memory may be operable to store instructions 106 executable by the processor. The functions, acts or tasks illustrated in the figures or described herein may be performed by the programmed processor executing instructions stored in the memory. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system may further include a display 112, such as a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor, or specifically as an interface with the software stored in the memory or in the drive unit 108.

Additionally, the computer system may include an input device 114 configured to allow a user to interact with any of the components of system. The input device may be a number pad, a keyboard, or a cursor control device, such as a mouse, or a joystick, touch screen display, remote control or any other device operative to interact with the system.

The computer system may also include a disk or optical drive unit. The disk drive unit may include a computer-readable medium in which one or more sets of instructions, e.g. software, may be embedded. Further, the instructions may perform one or more of the methods or logic as described herein. The instructions may reside completely, or at least partially, within the memory and/or within the processor during execution by the computer system. The memory and the processor also may include computer-readable media as discussed above.

The present disclosure contemplates a computer-readable medium that includes instructions or receives and executes instructions responsive to a propagated signal, so that a device connected to a network 118 may communicate voice, video, audio, images or any other data over the network. Further, the instructions may be transmitted or received over the network via a communication interface 116. In this regard, the deal meter system 100 may use communication interface 116 communicate with the promotion database 120, historical information database 122, users 124, and/or merchants 126. The communication interface may be a part of the processor or may be a separate component. The communication interface may be created in software or may be a physical connection in hardware. The communication interface may be configured to connect with a network, external media, the display, or any other components in system, or combinations thereof. The connection with the network may be a physical connection, such as a wired Ethernet connection or may be established wirelessly as discussed below. Likewise, the additional connections with other components of the system may be physical connections or may be established wirelessly. In the case of a service provider server, the service provider server may communicate with users through the communication interface.

The network may include wired networks, wireless networks, or combinations thereof. The wireless network may be a cellular telephone network, an 802.11, 802.16, 802.20, or WiMax network. Further, the network may be a public network, such as the Internet, a private network, such as an intranet, or combinations thereof, and may utilize a variety of networking protocols now available or later developed including, but not limited to TCP/IP based networking protocols.

The computer-readable medium may be a single medium, or the computer-readable medium may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium may include a solid-state memory such as a memory card or other package that houses one or more non-volatile read-only memories. The computer-readable medium also may be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. In this regard, the computer-readable medium may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

### Redemption Number Targeting

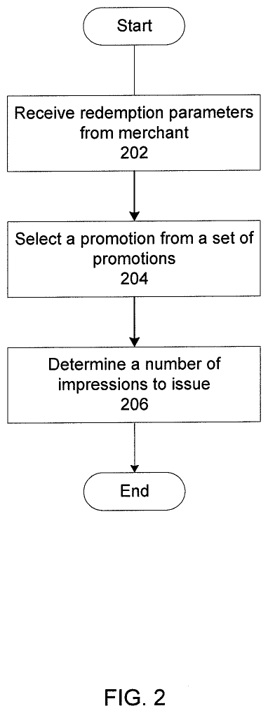

In some embodiments, a merchant may decide upon a target number of redemptions that would best service its business interests. This may occur for a variety of reasons, such as, for example, inventory stock and/or marketing considerations. In such embodiments, a merchant's redemption parameters may indicate a total number of allowable redemptions. FIG. 2 illustrates a series of operations that the deal meter system may use to implement a redemption number targeting function to address this demand. In operation 202, the deal meter may be embodied by an apparatus, such as deal meter system 100, that include means, such as processor 102, communication interface 116, or the like, for receiving the redemption parameters from the merchant. As noted above, in this embodiment one redemption parameter indicates the merchant's target number of redemptions. The redemption parameters may additionally include a promotion or a set of promotions that the merchant is willing to provide. In embodiments in which a promotion or set of promotions is received, the deal meter system 100 may cause the promotion(s) to be stored in promotion database 120.

In operation 204, the deal meter may include means, such as processor 102 or the like, for selecting a promotion from a set of promotions based on the redemption parameters. The set of promotions may be retrieved from promotion database 120 and/or from the merchant's redemption parameters. In some embodiments where only a single promotion is identified, the lone promotion is selected by default. In embodiments where multiple promotions are available, the deal meter system 100 may retrieve promotion acceptance and promotion redemption ratios from the historical database 122 for each of the relevant promotions, and may subsequently select a promotion based on the relevant promotion acceptance and promotion redemption ratios. In one embodiment, the promotion with the highest promotion acceptance ratio and/or promotion redemption ratio may be selected. In other embodiments, a promotion is chosen randomly. Embodiments in which other methods for selecting a promotion are additionally contemplated.

In operation 206, the deal meter may include means, such as processor 102 or the like, for determining a number of impressions based on the redemption parameters, wherein each impression correlates to the selected promotion. In this embodiment, the number of impressions will, of course, be greater than or equal to the number of redemptions. Additionally, the number of impressions may be based on other redemption parameters. In one embodiment, the number of impressions is further based on the selected promotion. In this regard, the number of impressions may be based on specific features of the selected promotion, or may be based on the promotion acceptance ratio and the promotion redemption ratio of the selected promotion. In some embodiments, the procedure ends after determining the number of impressions. In other embodiments, however, an impression issuance schedule may be created based on the redemption parameters, as will be discussed below.

In some embodiments, the redemption number targeting operations of FIG. 2 may be used for redemption targeting in specific time periods. For instance, a merchant may want to clear out all of a certain type of inventory by a certain date. As another example, the merchant may desire multiple redemption number targets. For example, due to seasonal variation in supply, demand, and staffing, a merchant may want different numbers of redemptions in different months of the year (e.g., a ski shop may desire a different number of redemptions in January than in June, etc.). Accordingly, using this redemption number targeting procedure, a variety of types of merchant redemption targets can be satisfied.

### Redemption Rate Targeting

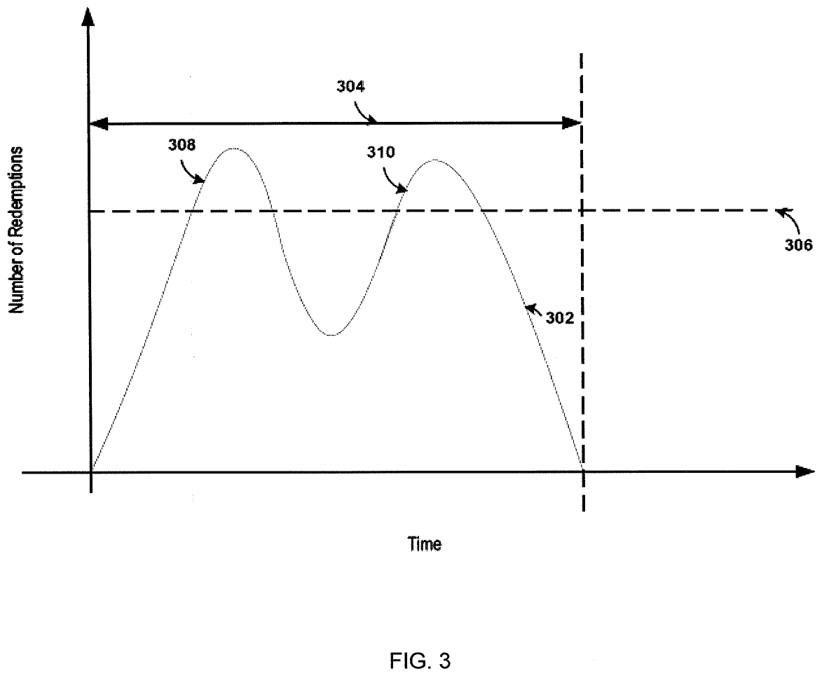

In some embodiments, merchants may additionally or alternatively desire a certain rate of redemption of promotions. In this regard, one purpose of the promotion may be to generate consistent customer traffic. For instance, by having a steady stream of redemptions, the merchant can more easily plan staffing and inventory levels. In such situations, although increased customer traffic is a goal, the merchant may be unable to handle individual large spikes in the number of redemptions. Consider FIG. 3, for example, which shows a graph of a sequence of promotion redemption for a traditional promotion having a fixed duration 304. The number of redemptions 302 for the promotion may fluctuate and may exhibit two spikes: one during an initial time period 308 (e.g., the first week) and another during a subsequent time period 310 (e.g., the last week of the deal's duration). In this example, these spikes exceed a merchant's capacity 306 to handle redemptions. In situations where they lack the capacity to accommodate the number of redemptions occurring during these redemption spikes, merchants may have been discouraged from using promotions to generate customer traffic.

Accordingly, the deal meter can reduce the severity of redemption spikes and create a promotion redemption rate that would be more enticing to merchants. One way in which the deal meter can accomplish this goal is to stagger the promotion terms of various impressions so that, even if a customer is most likely to redeem a promotion near the beginning or the end of the relevant promotion term, the variety of promotion terms can be selected in a way that spreads the redemptions out more evenly.

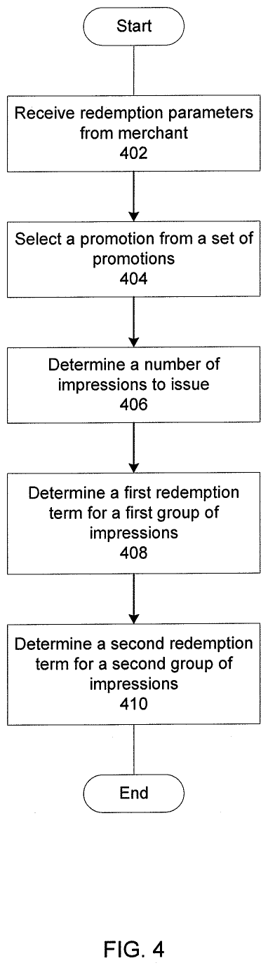

FIG. 4 illustrates a series of operations that the deal meter system may use to implement a redemption number targeting function to address this demand. In operation 402, the deal meter may be embodied by an apparatus, such as deal meter system 100, that include means, such as processor 102, communication interface 116, or the like, for receiving the redemption parameters from the merchant. As noted above, in this embodiment one redemption parameter indicates a promotion redemption rate.

In operation 404, the deal meter may include means, such as processor 102 or the like, for selecting a promotion from a set of promotions based on the redemption parameters. The promotion may be selected in a manner similar to that of operation 204, above. In operation 406, the deal meter may include means, such as processor 102 or the like, for determining a number of impressions based on the redemption parameters, wherein each impression correlates to the selected promotion, as also discussed above.

In operation 408, the deal meter may include means, such as processor 102 or the like, for determining a first redemption term for a first group of the impressions. In some embodiments, the redemption term may be based only on the redemption parameters. In other embodiments, the redemption term may be based on a promotion acceptance ratio or a promotion redemption ratio. In this regard, the higher the acceptance and/or redemption ratio, the greater the likelihood for redemption spikes. Of course, other bases for determining the redemption terms could be the selected promotion and/or the number of impressions.

In operation 410, the deal meter may include means, such as processor 102 or the like, for determining a redemption term for a second group of the impressions. In some embodiments, this second redemption term may be based only on the redemption parameters. In other embodiments, this redemption term may be based on a promotion acceptance ratio or a promotion redemption ratio retrieved from historical information database 122. In one such embodiment, the redemption term of the second group of impressions may be based on the promotion acceptance and redemption ratios of the first group of impressions. Accordingly, based on real-time information regarding acceptance and redemption of the first group of impressions, the redemption term of the second group of impressions can be determined to ensure that any spikes in redemptions for the second group of impressions will not coincide with additional spikes in redemptions for the first group of impressions. In other words, using two impression groups, the deal meter system 100 is able to stagger impressions in a way that can decrease the likelihood that spikes, such as those shown in FIG. 3 above, will affect the merchant.

In one embodiment, the first and second groups of impressions may be identified by determining an impression issuance schedule based on the redemption parameters and at least one of the promotion acceptance ratio, the promotion redemption ratio, or the promotion itself. An impression issuance schedule may include a number of impressions to be issued at a first time, but may also include a number of impressions to be issued at a second time, a third time, and so forth. In this regard, the impression issuance schedule is a projection based on known data. At the very least, then, the impression issuance schedule may be based on the determined number of impressions.

In this embodiment, the deal meter system 100 may assign redemption terms to the promotion based on when a corresponding impression is schedule for issuance. Thus, the redemption term for the promotion may be based not only on the redemption parameters, but also on the impression issuance schedule. Moreover, in this embodiment, operations 408 and 410 may be used to determine the redemption terms of first and second groups of impressions in the impression issuance schedule. In addition, although redemption terms can alter the promotion redemption rate, other variables can have a similar effect. For instance, the deal meter system 100 may additionally or alternatively modify the promotion identified by an impression, given that some promotions have higher promotion acceptance and redemption ratios than others.

### Pre-Featured Promotions

In many cases, there may be no merchant-specific historical data that can be used to develop the impression issuance schedule. For instance, a merchant may never have previously offered promotions, or historical data regarding the promotions may never have been recorded. In such situations, when the merchant provides redemption parameters to the deal meter, the deal meter may develop an impression issuance schedule based on historical information stored in historical information database 122 using similar promotions or similar merchants. In addition, in some embodiments, rather than immediately featuring a promotion to a large number of customers, the deal meter may initiate a pre-feature promotion in which impressions are issued to a relatively small user population specifically for the purpose of gathering information regarding the promotion acceptance ratio and promotion redemption ratio for the promotion, without exposing the merchant to potential overwhelming redemption spikes that may accompany issuance of impressions to a large user population.

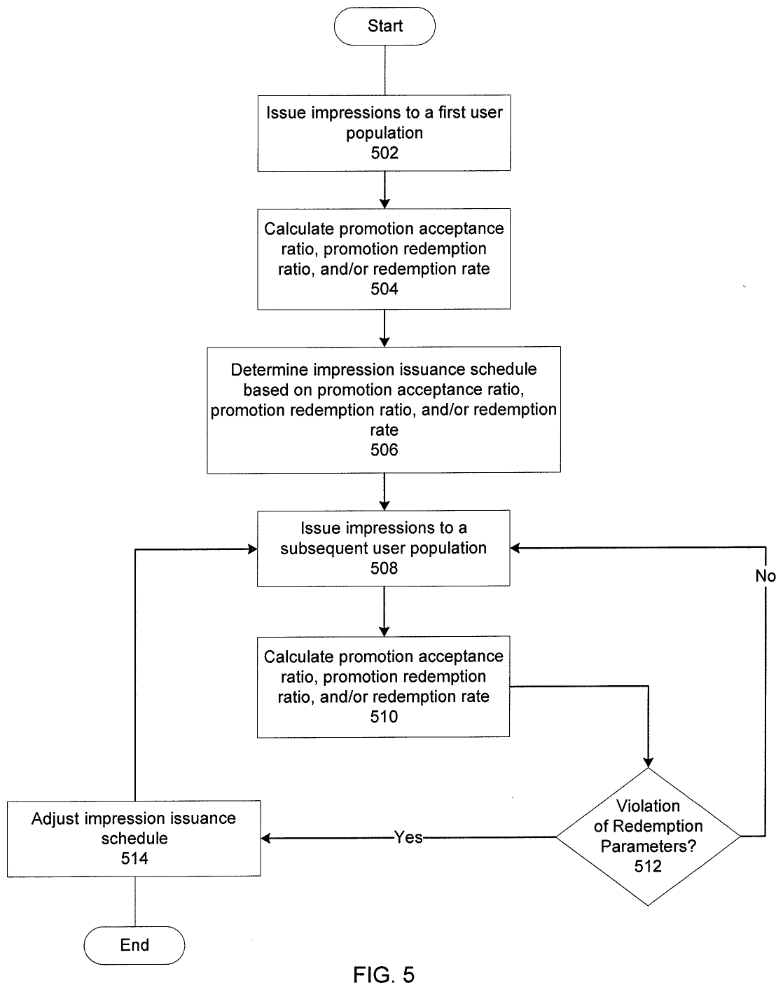

To accomplish this, the deal meter system 100 may also modify the user population that may receive an impression based on when a group of impressions is scheduled for issuance. FIG. 5 illustrates a series of operations that the deal meter system may use to implement a pre-feature promotion. In operation 502, the deal meter may include means, such as processor 102, communication interface 116, or the like, for issuing impressions to a first user population based on the redemption parameters received from the merchant. This first user population may be as small as desired so long as it provides a large enough sample size to determine an accurate promotion acceptance ratio, promotion redemption ratio, and/or promotion redemption rate. Accordingly, in operation 504, the deal meter may include means, such as processor 102 or the like, for calculating a promotion acceptance ratio, promotion redemption ratio, and/or redemption rate from the impressions issued to the first user population.

In operation 506, the deal meter may include means, such as processor 102 or the like, for determining an impression issuance schedule based on the calculated promotion acceptance ratio, promotion redemption ratio, and/or redemption rate. In this manner, even when no information was originally known about the merchant, the deal meter system can produce an impression issuance schedule based on a pre-feature promotion. In this regard, as one element of determining the impression issuance schedule comprises updating the user population associated with the impression issuance schedule. Subsequently, in operation 508, the deal meter system 100 may include means, such as processor 102, communication interface 116, or the like, for issuing impressions to the updated user population. In operation 510, the deal meter system 100 may include means, such as processor 102, for calculating promotion acceptance ratio, promotion redemption ratio, and/or redemption rate of the subsequent user population.

In operation 512, the deal meter system 100 may include means, such as processor 102, communication interface 116, or the like, for determining whether merchant's redemption terms are being met or not. If the redemption terms are being met, the procedure continues to operation 508, for issuance of additional impressions according to the adjusted impression issuance schedule.

If the merchant's redemption terms are not being met, in operation 514 the deal meter system 100 may include means, such as processor 102, communication interface 116, or the like, for adjusting the impression issuance schedule in view of the merchant's redemption parameters. In the case that a redemption parameter includes a total number of redemptions, and that total number of redemptions has been reached, the procedure ends. Otherwise, the procedure continues to operation 508, for issuance of additional impressions according to the adjusted impression issuance schedule.

As shown with respect to FIG. 5, the deal meter may use pre-featured deals to gather data regarding promotion acceptance and redemption ratios, and promotion redemption rates, and to subsequently offer promotions using an impression issuance schedule. The deal meter may refine the acceptance rates and redemption rates for subsequent periods of time. As described previously, the deal meter may adjust the promotions offered over the course of time based on prior promotion acceptance ratios and redemption ratios for promotions, in order to create a better and more personalized customer experience.

### First Illustrative Example

### Merchant Having Excess Goods

In a first example of the deal meter system, a manager at a department store, ACME, discovers that the store has 1000 surplus widgets in inventory after a holiday season. Because the widgets take up space that could otherwise be used for new inventory, the manager wishes to sell off the extra widgets and potentially also generate additional customer traffic. Having previously provided a widget promotion using the promotion marketing service, the manager decides to initiate a new promotion using the deal meter system to address the excess supply of widgets and also boost sales.

Accordingly, the ACME manager sends redemption parameters to the deal meter system 100. In this case, the redemption parameter may only comprise the target total number of redemptions (1000). In operation 202, the deal meter system 100 receives the redemption parameters and selects a promotion. By consulting promotion database 120, the deal meter system 100 retrieves a previously stored promotion for widgets at ACME. Because this is the only promotion associated with ACME, the deal meter system 100 selects this promotion. In operation 204, the deal meter system 100 determines a number of impressions to issue. The deal meter system 100 thus queries historical information database 122 for information relevant to the identified promotion from ACME. In this case, a promotion acceptance ratio of 50% is retrieved, and a promotion redemption ratio of 80% is retrieved. Based on these retrieved values, the deal meter system 100 is able to determine that to achieve 1000 redemptions, the system must receive 1250 accepted promotions (1000 divided by 0.8). Similarly, to receive 1250 accepted promotions, the system must issue 2500 impressions (1250 divided by 0.5). Accordingly, in operation 206, the deal meter system 100 determines that it must issue 2500 impressions to hit the target number of redemptions.

### Second Illustrative Example

### Service Provider Lacking Customers

In a second example of the deal meter system, a manager at a hair salon has noticed a recent slump in business. The salon has 10 stylists, who can handle 8 customers per day, but each stylist is only busy about 75% of the time. Accordingly, the manager decides to offer a promotion to increase customer traffic through the store and, hopefully, generate repeat customers. The hair salon has never previously offered any promotions, but seeks to use the deal meter system to help develop a plan.

Accordingly, the salon manager sends redemption parameters to the deal meter system 100. Unlike the situation with the ACME department store, a redemption parameter in this situation may comprise a target promotion redemption rate. In this case, the manager determines that each of the 10 stylists could handle 4 additional appointments per day, and therefore determines that the salon has the capacity to handle 40 more appointments per day. Accordingly, the manager determines that a target redemption rate of 20 redemptions per day would be ideal, because it would allow some schedule flexibility. In addition, the salon manager sends a promotion ($20 for $40 towards an appointment with a hair stylist). In operation 402, the deal meter system 100 receives the redemption parameters. By consulting promotion database 120, the deal meter system 100 determines that no prior promotions have been used by the hair salon. However, because the salon manager transmitted a promotion, in operation 404, the deal meter system 100 is able to simply select the promotion transmitted by the salon manager.

In operation 406, the deal meter system 100 determines a number of impressions to issue. In this regard, the deal meter system 100 queries historical information database 122, which does not have any relevant historical information. However, the historical information database 122 does have information regarding similar promotions that have been offered at other hair salons. Based on these retrieved values, the deal meter system 100 is able to determine that a similar promotion had a promotion acceptance ratio of 25% and a promotion redemption ratio of 50%. Accordingly, because the hair salon has a target of 20 redemptions per day, similar to the deal meter system 100 is able to determine that there must be 40 accepted promotions, and accordingly 160 issued impressions per day.

In operation 408, the deal meter system 100 then determines a first redemption term for a first group of impressions. Although 160 impressions must be issued per day to average 20 redemptions per day, the hair salon is not capable of servicing more than 40 redemptions per day. With only a single group of impressions, however, this is not a significant concern, and the deal meter system 100 may set a redemption term of one month.

In operation 410, the deal meter system 100 then determines a second redemption term for a second group of impressions to be issued the following day. Although an average of 160 impressions must be issued per day to hit the target redemption rate, the promotion term of this second group of impressions must be shifted away from the redemption term of the first group, to avoid a potential redemption spike. Accordingly, the redemption term is set for one month, but the effective date and expiration date are shifted back one day. The deal meter system 100 may subsequently iterate this process for additional days until the merchant decides to end the promotion. In the present situation, however, the merchant is satisfied that a target redemption rate can be achieved, while the promotion marketing service is able to receive business from a merchant who may not have been interested in a promotion without the ability to meter its redemption.

### CONCLUSION

The illustrative examples described herein are intended to provide a general understanding of various embodiments. They are not intended to serve as a complete description of all of the elements and features of any apparatus, processor, or system that utilizes the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the figures are merely representational and may not be drawn to scale. Certain proportions within the figures may be exaggerated, while other proportions may be minimized. Accordingly, the disclosure and the figures are to be regarded as illustrative rather than restrictive.

Many modifications and other embodiments of the inventions set forth herein will come to mind to one skilled in the art to which these inventions pertain having the benefit of the teachings presented in the foregoing descriptions and the associated drawings. Although specific terms are employed herein, they are used in a generic and descriptive sense only and not for purposes of limitation. Therefore, it is to be understood that the inventions are not to be limited to the specific embodiments disclosed and that modifications and other embodiments are intended to be included within the scope of the appended claims. Thus, the scope of this application is to be determined by the following claims and their equivalents.

1. (canceled)

2. An apparatus comprising:
a processor including one or more processing devices configured to perform independently or in tandem to execute hard-coded functions or execute software instructions;
a user interface;
a communication interface; and
a memory comprising one or more volatile or non-volatile electronic storage devices storing computer-readable instructions configured, when executed, to cause the processor to:
provide, via one of e-mail, text message, application alert, or mobile application, to each of a first plurality of consumer devices, an indication of an availability of electronic media, the electronic media having a first expiration date;
receive, from at least one consumer device, a first acceptance of the electronic media;
provide, to the at least one consumer device, first content indicative of the electronic media, the first content comprising a display of the first expiration date;
receive, from a second consumer device, a second acceptance of the electronic media;
modify the first content to create second content comprising a display of a second expiration date; and
present, via display at the second consumer device, second content, the second content comprising the display of the second expiration date.

3. The apparatus of claim 1, wherein the indication of the availability of electronic media does not include the first expiration date.

4. The apparatus of claim 1, wherein the second expiration date is based at least in part on the receipt of the first acceptance from the at least one consumer device.

5. The apparatus of claim 1, wherein the memory comprising one or more volatile or non-volatile electronic storage devices storing computer-readable instructions configured, when executed, to further cause the processor to:
receive, prior modifying the first content, one or more additional acceptances of the electronic media associated with one or more additional consumer devices of the first plurality of consumer devices; and
wherein modifying the first content is in real-time and is further based on the receipt of each of the one or more additional acceptances of the electronic media.

6. The apparatus of claim 1, wherein the second expiration date is based on a schedule.

7. The apparatus of claim 1, wherein the memory comprising one or more volatile or non-volatile electronic storage devices storing computer-readable instructions configured, when executed, to further cause the processor to:
provide, via one of e-mail, text message, application alert, or mobile application, to each of a second plurality of consumer devices at a second time, an indication of the availability of the electronic media;
receive, from a third consumer device, a third acceptance of the electronic media, wherein the third consumer device is one of the second plurality of consumer devices;
modify the second content to create third content comprising a display of a third expiration date, wherein the third expiration date is based prior acceptances of the electronic media; and
provide, to the third consumer device, third content indicative of the electronic media, the third content comprising a display of the third expiration date.

8. The apparatus of claim 7, wherein the second plurality of consumer devices is determined prior to providing the indication of the availability of the electronic media to the first plurality of consumer device; and
wherein the memory comprising one or more volatile or non-volatile electronic storage devices storing computer-readable instructions configured, when executed, to further cause the processor to:
modify the second plurality of consumer devices to update the number of consumer devices in the second plurality of consumer devices based on received acceptances from consumer devices in the first plurality of consumer devices.

9. A computer program product comprising at least one non-transitory computer-readable storage medium having computer-executable program code instructions stored therein, the computer-executable program code instructions comprising program code instructions for:
providing, via one of e-mail, text message, application alert, or mobile application, to each of a first plurality of consumer devices, an indication of an availability of electronic media, the electronic media having a first expiration date;
receiving, from at least one consumer device, a first acceptance of the electronic media;
provide, to the at least one consumer device, first content indicative of the electronic media, the first content comprising a display of the first expiration date;
receiving, from a second consumer device, a second acceptance of the electronic media;
modifying the first content to create second content comprising a display of a second expiration date; and
presenting, via display at the second consumer device, second content, the second content comprising the display of the second expiration date.

10. The computer program product according to claim 9, wherein the indication of the availability of electronic media does not include the first expiration date.

11. The computer program product according to claim 9, wherein the second expiration date is based at least in part on the receipt of the first acceptance from the at least one consumer device.

12. The computer program product according to claim 9, wherein the computer-executable program code instructions further comprise program code instructions for:
receiving, prior modifying the first content, one or more additional acceptances of the electronic media associated with one or more additional consumer devices of the first plurality of consumer devices; and
wherein modifying the first content is in real-time and is further based on the receipt of each of the one or more additional acceptances of the electronic media.

13. The computer program product according to claim 9, wherein the second expiration date is based on a schedule.

14. The computer program product according to claim 9, wherein the computer-executable program code instructions further comprise program code instructions for:
providing, via one of e-mail, text message, application alert, or mobile application, to each of a second plurality of consumer devices at a second time, an indication of the availability of the electronic media;
receiving, from a third consumer device, a third acceptance of the electronic media, wherein the third consumer device is one of the second plurality of consumer devices;
modifying the second content to create third content comprising a display of a third expiration date, wherein the third expiration date is based prior acceptances of the electronic media; and
providing, to the third consumer device, third content indicative of the electronic media, the third content comprising a display of the third expiration date

15. The computer program product according to claim 14, wherein the second plurality of consumer devices is determined prior to providing the indication of the availability of the electronic media to the first plurality of consumer device; and
wherein the computer-executable program code instructions further comprise program code instructions for:
modifying the second plurality of consumer devices to update the number of consumer devices in the second plurality of consumer devices based on received acceptances from consumer devices in the first plurality of consumer devices.

16. A method comprising:
providing, via one of e-mail, text message, application alert, or mobile application, to each of a first plurality of consumer devices, an indication of an availability of electronic media, the electronic media having a first expiration date;
receiving, from at least one consumer device, a first acceptance of the electronic media;
provide, to the at least one consumer device, first content indicative of the electronic media, the first content comprising a display of the first expiration date;
receiving, from a second consumer device, a second acceptance of the electronic media;
modifying the first content to create second content comprising a display of a second expiration date; and
presenting, via display at the second consumer device, second content, the second content comprising the display of the second expiration date.

17. The method of claim 16, wherein the indication of the availability of electronic media does not include the first expiration date

18. The method of claim 16, wherein the second expiration date is based at least in part on the receipt of the first acceptance from the at least one consumer device.

19. The method of claim 16, further comprising:
receiving, prior modifying the first content, one or more additional acceptances of the electronic media associated with one or more additional consumer devices of the first plurality of consumer devices; and
wherein modifying the first content is in real-time and is further based on the receipt of each of the one or more additional acceptances of the electronic media.

20. The method of claim 16, further comprising:
providing, via one of e-mail, text message, application alert, or mobile application, to each of a second plurality of consumer devices at a second time, an indication of the availability of the electronic media;
receiving, from a third consumer device, a third acceptance of the electronic media, wherein the third consumer device is one of the second plurality of consumer devices;
modifying the second content to create third content comprising a display of a third expiration date, wherein the third expiration date is based prior acceptances of the electronic media; and
providing, to the third consumer device, third content indicative of the electronic media, the third content comprising a display of the third expiration date.

21. The method of claim 20, wherein the second plurality of consumer devices is determined prior to providing the indication of the availability of the electronic media to the first plurality of consumer device; and
the method further comprising:
modifying the second plurality of consumer devices to update the number of consumer devices in the second plurality of consumer devices based on received acceptances from consumer devices in the first plurality of consumer devices.
